(19) United States
(12) Patent Application Publication
(10) Pub. No.: US 2021/0131115 A1
(43) Pub. Date: May 6, 2021

(54) FLOOR, WALL AND CEILING CLADDING

(71) Applicants: Lohmann GmbH & Co. KG, Neuwied (DE); Logis AG, Heldenstein (DE); Logis Innovations GmbH, Heldenstein (DE); Logis Technologies GmbH, Heldenstein (DE)

(72) Inventors: Thomas FOGEL, Neuwied (DE); Christoph FRIEB, Heldenstein (DE); Martin HAAG, München (DE)

(73) Assignees: Lohmann GmbH & Co. KG, Neuwied (DE); Logis AG, Heldenstein (DE); Logis Innovations GmbH, Heldenstein (DE); Logis Technologies GmbH, Heldenstein (DE)

(21) Appl. No.: 16/478,418

(22) PCT Filed: Jan. 16, 2018
(86) PCT No.: PCT/EP2018/051003

§ 371 Date: Jul. 16, 2019

(30) Foreign Application Priority Data
Jan. 16, 2017 (DE) 10 2017 100 759.8

(51) Int. Cl. E04F 13/08; E04F 15/02; E04F 15/10; E04C 2/28; E04C 2/284; B32B 7/12; B32B 15/20; B32B 15/04; B32B 5/18; B32B 5/02; B32B 15/14

(52) U.S. Cl. CPC E04F 13/0866; B32B 2307/202; E04F 13/0875; E04F 15/0215; E04F 15/02172; E04F 15/107; E04C 2/28; E04C 2/284; B32B 7/12; B32B 15/20; B32B 15/046; B32B 5/18; B32B 5/02; B32B 15/14; B32B 2607/00; B32B 2419/04; B32B 2255/26; B32B 2266/025; B32B 2262/103; B32B 2262/106; E04F 13/0885

(57) ABSTRACT

The present disclosure relates to a floor, wall and ceiling cladding for protection, damping and insulation purposes, comprising a combination of a support layer building board having a first surface and a second surface, said support layer building board comprising a lightweight building board, of a first top coating arranged on the first surface, said first top coating comprising a polyurethane, a polyurea and/or epoxy resin, and of an adhesive fastening arranged on the second surface. The present invention further relates to a method for producing a floor, wall and ceiling cladding.

### TECHNICAL FIELD

The present invention relates to a floor, wall, and ceiling cladding for protection, damping and insulation purposes as well as a method for its production.

### PRIOR ART

In the construction industry, there is a desire to provide functional surfaces allowing for quick and cost-effective installation. As far as floor, wall and ceiling cladding is concerned, it is helpful to work with functionalised lightweight construction elements. These usually form finished products that only have to be installed at the site where they are used. Additional finishing steps such as applying a spray coating on site after installation can thus be rendered obsolete.

For example, U.S. Pat. No. 6,481,172 B1 describes a structural wall element with an insulating foam core surrounded by paper layers impregnated with polyurethane, polystyrene or polyisocyanates. It is moreover known in this field to work with decorative elements. For example, US 2016/0101601 A1 describes a metallised, flexible polymer layer with coloured polyurethane adhesive for fastening. US 2014/0202097 A1 describes a system of lightweight building boards connected in a frame system by a certain type of channels. Better insulation and acoustics are two of the core issues in this context, for example as illustrated in US 2014/0083040 A1 and also in EP 0 965 701 A1.

US 2004/0123555 A1 relates to prefabricated walls or floors with a cardboard core coated with a layer of flame-retardant material. WO 2015/178353 A1 relates to a coating for concrete comprising a curable resin layer and a carrier layer. WO 2014/001152 A1 relates to a wall element for building façades with a sandwich design including a core layer comprised of an insulating material encased by two metallic layers. DE 10 2009 036 541 A1 relates to a foam panel comprising a carrier and at least one multi-layer composite board adhering to the carrier, wherein the multi-layer composite board consists of a core layer and a decorative layer and wherein the carrier comprises a polyurethane foam.

Generally, the above products for floor, wall and/or ceiling cladding are all limited to just a few use cases. Apart from that, the installation of the products described above is still associated with multiple time-consuming and costly work steps.

### ILLUSTRATION OF THE INVENTION

Starting from the prior art, it is one object of the present invention is to provide an improved floor, wall and ceiling cladding for protection, damping and insulation purposes as well as a corresponding manufacturing process.

The problem is solved by way of a floor, wall and ceiling cladding with the features of claim 1. Advantageous further embodiments derive from the dependent claims.

Accordingly, a floor, wall and ceiling cladding for protection, damping and insulation purposes is proposed. Pursuant to the invention, this comprises a combination of a support layer having a first surface and a second surface, wherein the support layer comprises a lightweight building board, a first top coating arranged on the first surface, wherein the first top coating comprises a polyurethane, polyuria, and or/epoxy resin and an adhesive fastening arranged on the second surface.

The combination of support layer, top coating and adhesive fastening forms a finished product that significantly reduces the number of work steps at the assembly site. It eliminates time-consuming coating processes at the assembly site like additional spraying procedures, for example. In particular, it is no longer necessary to elaborately prepare the installation site for the coating step. The floor, wall and ceiling cladding can be glued in as it is without the need for an additional adhesive system to be applied. Overall, the floor, wall and ceiling cladding described above facilitates and accelerates assembly.

Moreover, resilient floor, wall and ceiling cladding can be provided at comparatively low weight. The components of the floor, wall and ceiling cladding can be coordinated such that the individual layers do not come apart even when subjected to high mechanical loads or in the event of large temperature variations. The support layer gives the floor, wall and ceiling cladding sufficient strength and rigidity at comparatively low weight. By coating the support layer with a plastic on one side and an adhesive on the other, bonding strength is achieved that is guaranteed also in the event of severe deformation of the cladding.

The plastic used for the top coating can be adapted to the desired field of use through appropriate selection or modification. This results in a universal field of use for the floor, wall and ceiling cladding. In addition, the design of the floor, wall and ceiling cladding allows for comparatively high impact resistance. Moreover, the floor, wall and ceiling cladding may contribute to noise insulation. This is made possible in particular by the top coating made of polyurethane, polyurea and/or epoxy resin. If, for example, a partition wall is equipped with floor, wall and ceiling cladding, undesirable noise transmission from one side of the wall to the other can be prevented.

Apart from that, the floor, wall and ceiling cladding can also be used for thermal insulation purposes.

In a preferred embodiment, the lightweight building board comprises plastics, lightweight metals such as aluminium and/or fibre-reinforced composites or a combination thereof. The lightweight building board offers the strength required for the application at a relatively low weight. This has the advantage that the floor, wall and ceiling cladding is easy to process further or install. The low weight of the floor, wall and ceiling cladding furthermore positively impacts the total weight of the floor, wall or ceiling.

In the case of fibre-reinforced composites, reinforcing fibres can be embedded in a polymer matrix.

Carbon fibres, glass fibres, plastic fibres, natural fibres and/or metal fibres can be used as reinforcing fibres.

In addition to providing good strength at comparatively low weight, the use of aluminium allows also for providing the function of an infra-red reflecting coating at the same time.

In a further embodiment, a second top coating is arranged on the first top coating. This allows for the integration of yet another functional layer into the floor, wall and ceiling cladding. In the alternative, the second top coating can be arranged between the first surface of the support plate and the first top coating, between the second surface and the adhesive layer or on the side of the adhesive layer facing away from the support plate.

In a preferred embodiment, the lightweight building board comprises a polymer encased between two aluminium layers. Compared to conventional floor, wall and ceiling cladding, such a lightweight building board is characterised by comparatively small thickness relative to its high strength and rigidity. For example, compared to a coated screen printing panel, the thickness of a lightweight building board consisting of a polymer embedded in aluminium can be reduced by 75%. In addition, this type of floor, wall and ceiling cladding provides for comparatively good thermal insulation properties.

In a further development, the lightweight building board comprises a polymer encased between two aluminium layers. By providing the polymer layer in the form of a foam layer, the weight of the floor, wall and ceiling cladding can be reduced even further. In addition to its low weight, such a layer is characterised by its small thickness whilst providing and sufficient strength. Sufficient strength means that the strength provided is sufficient for the usual use cases for floor, wall and ceiling cladding. Furthermore, such a lightweight building board is suitable for being adjusted to the surrounding geometry. The floor, wall and ceiling cladding is also suitable for assembly across corners. Overall, this type of lightweight building board provides good malleability during assembly and makes do with a comparatively small weight and layer thickness.

All in all, such a lightweight building board complements the properties of a sandwich design. The lightweight building board comprising a polymer foam that is encased between two aluminium layers is characterised by comparatively high shear strength, high load-bearing capacity and a generally high degree of rigidity. Furthermore, the polymer foam has comparatively good thermal insulating properties.

In another preferred embodiment, the polymer foam is a polypropylene foam or a polyethylene foam. Due to the low density of the polypropylene foam, it is possible to provide a comparatively light lightweight building board. In addition, polypropylene is characterised by high fatigue resilience. This is particularly advantageous in case the floor, wall and ceiling cladding is subject to frequent application of force, for example blows.

In another preferred embodiment, the strength properties of the lightweight building board are greater than the strength properties of the top coating. Thus, gaps can be bridged in case surfaces are uneven. Consequently, the properties of the functional cover layer can be utilised across the entire surface of the cover layer.

This relative strength distribution between the lightweight building board and the top coating allows for enhanced pressure distribution when forces are applied locally to the floor, wall and ceiling cladding.

In another preferred embodiment, the top coating has an anti-slip coefficient of at least R10. An anti-slip coefficient of R10 according to DIN 51130 renders anti-slip coatings obsolete.

In another preferred embodiment, the top coating has a slide-friction coefficient of at least 0.6 pD. This slide-friction coefficient is certified according to VDI Guideline 2700/Sheet 14.

In a preferred embodiment, the top coating has a smooth, rough or textured outer surface. The top coating can be adapted to the respective use case. If sliding properties of the floor, wall and ceiling cladding are required, the top coating can be configured as a smooth top coating to exhibit small slide-friction coefficients. If, however, the specific use case requires anti-slip properties, the top coating can be configured as a rough or structured top coating.

In another embodiment, the first top coating and/or a second top coating comprises nano particles coated with a waxy layer. This allows providing a contact angle greater than 90°, giving the surface of the top coating hydrophobic properties. One example of such a top coating is shown inter alia in WO 2010/106370 A1.

This way, it becomes more difficult for water, oil, mould, dirt etc. to adhere to the surface. Consequently, it is easier to clean the floor, wall and ceiling cladding and keep them that way.

In another embodiment, the first top coating and/or a second top coating comprises bound silver ions, copper ions and/or terbutryn. Including silver ions in the top coating provides the surface of the floor, wall and ceiling cladding with antibacterial properties. Including copper ions in the top coating provides the surface of the floor, wall and ceiling cladding fungicide properties. Including terbutryn in the top coating provides the surface of the floor, wall and ceiling cladding algicide properties.

In another preferred embodiment, the first top coating and/or a second top coating comprises a fabric consisting in aluminium, stainless steel, copper or carbon fibres. That way, the floor, wall and ceiling cladding can be used for reflecting electro-magnetic radiation.

In another embodiment, the first top coating and/or a second top coating comprises soot particles or electrically conductive fibres. As a result, the floor, wall and ceiling cladding exhibits increased electrical conductivity, which is also reflected in antistatic behaviour.

In another preferred embodiment, the adhesive fastening comprises a backing-based adhesive tape, a transfer adhesive tape or a liquid adhesive.

A backing-based adhesive tape, in particular a double-sided backing-based adhesive tape, has the ability to control for example its elastic properties via the backing material and the latter's properties (foam, paper, film). In addition, by being able to choose the type of adhesive used on either side of the backing material, the adhesive properties with respect to different surfaces can be matched to the particular characteristics of the surfaces to be glued together.

Similar characteristics are true for transfer adhesive tape without backing where, for example, also two different types of adhesive can be coated directly on top of each other, thus catering for different surfaces to be glued together. As a rule, however, the adhesive fastening is homogeneous and consists in just one material.

As far as resilience is concerned, transfer adhesive tape is substantially inferior to double-sided adhesive tape with a foam backing, but the former is usually more cost-effective, because no backing material is required.

Liquid adhesives are used for structural bonding, i.e. they are applied directly to one or both of the elements to be joined at the site of use, and then these two elements are brought into contact and glued together, for example under pressure or thermal impact.

Apart from that, today adhesive tape for structural bonding exists, too. The term structural here means that the connection exhibits a uniform structure after the gluing step. Any disruption of the connection no longer necessarily occurs at the gluing point but anywhere in the system, for example in one of the elements to be glued together. As a rule, the bond is effected through pressure, thermal impact and/or humidity, allowing the adhesive to cure, so that the adhesive bond can be achieved.

Such connections, just like liquid bonds, are significantly stronger and more durable and can withstand more strain, but at the same time, they cannot be separated again without damaging the elements that were glued together. Generally, they require more time and resources for storage and processing. For example, storage at low temperatures may be required to prevent premature curing.

In another preferred embodiment, the backing-based adhesive tape comprises a soft-elastic backing, preferably a foam backing. Consequently, the adhesive fastening can also act as a levelling layer for uneven surfaces. In addition, the soft-elastic backing of the adhesive fastening increases the sound-insulating properties of the floor, wall and ceiling cladding.

In another preferred embodiment, the adhesive fastening comprises acrylates, polyurethane, epoxies, silicone and/or natural rubber.

In another preferred design, a tear-off film is arranged on the outer surface of the adhesive fastening. The tear-off film, also known as release liner, allows for easy storage. This way, the floor, wall and ceiling cladding can be also be stacked. Apart from that, due to the tear-off film, the floor, wall and ceiling cladding is ready for processing. After removing the tear-off film, the floor, wall and ceiling cladding can be applied directly at the site of use.

In a further embodiment, an additional fastening means is integrated into the layer structure of the top coating, the support layer and/or the adhesive fastening for fastening the floor, wall and ceiling cladding to a floor, wall or ceiling. Thus part of the forces exerted on the floor, wall and ceiling cladding can be absorbed and the load bearing on the adhesive fastening is reduced. Moreover, thus it can be ensured that, in the event that the adhesive fastening fails for example due to age, weather effects or chemical influences, the floor, wall and ceiling cladding is affixed securely to a floor, wall and/or ceiling.

The fastening means can be formed as screws, nails, suction plugs or Velcro. In addition, the fastening means can also be formed as a permanent magnet integrated in the support layer.

In a preferred embodiment, at least one transponder is integrated in the support layer or the first top coating, preferably an RFID transponder. This allows the floor, wall and ceiling cladding to interact with the environment. Depending on the type of transponder used, it is possible for example to identify moving objects in the vicinity of the floor, wall and ceiling cladding.

In another preferred embodiment, at least one line is integrated in the support layer or the first top coating, preferably an electric line. That way, cabling for example for electricity, internet or telephone can be integrated into the floor, wall and ceiling cladding. Then it is not necessary to produce or lay lines at the installation site. This way, even more time and costs can be saved.

In a further embodiment of the invention, the top coating is made of a flame-retardant material. This may for example comprise 20 to 80% by weight of a polycarbonate composition, 1 to 20% by weight of a laser-activated additive and 1 to 20% by weight of a phosphazene compound. This gives the floor, wall and ceiling cladding additional flame retardant properties.

The object specified above is moreover achieved by a wall element configured in accordance with the floor, wall and ceiling cladding pursuant to one of the above aspects.

The object specified above is moreover achieved by an adhesive tile configured in accordance with the floor, wall and ceiling cladding pursuant to one of the above aspects.

The object specified above is moreover achieved by a floor element configured in accordance with the floor, wall and ceiling cladding pursuant to one of the above aspects.

The object specified above is moreover achieved by a ceiling element configured in accordance with the floor, wall and ceiling cladding pursuant to one of the above aspects.

The object specified above is moreover achieved by a method for producing floor, wall and ceiling cladding with the features of claim 26. Advantageous further developments of the method derive from the dependent claims and from the present description as well as the figures.

Accordingly, a method is suggested for the production of a floor, wall and ceiling cladding, comprising the following steps: Providing the support layer, applying the adhesive fastening on the second surface of the support layer, and coating the first surface of the support layer with the first top coating using a spraying or casting method.

In a further embodiment, solid particles such as hard grain are sprayed or cast when the support layer is coated with the first top coating.

### BRIEF DESCRIPTION OF THE FIGURES

Preferred embodiments of the invention are illustrated in further detail by the subsequent description of the Figures. In this:

FIG. 1 shows a schematic sectional view of the layer configuration of a floor, wall and ceiling cladding,

FIG. 2 shows a schematic sectional view of the floor, wall and ceiling cladding of FIG. 1 with a tear-off film,

FIG. 3 shows a schematic sectional view of a floor, wall and ceiling cladding, comprising a lightweight building board consisting in a polymer foam encased between two aluminium layers,

FIG. 4 shows a schematic sectional view of the floor, wall and ceiling cladding of FIG. 3 in a state where it is applied to an uneven surface,

FIG. 5 shows a schematic sectional view of the floor, wall and ceiling cladding including a backing-based adhesive tape,

FIG. 6 shows a schematic sectional view of the floor, wall and ceiling cladding of FIG. 5 on an uneven surface,

FIG. 7 shows a schematic sectional view of the floor, wall and ceiling cladding with three adhesive layers,

FIG. 8 shows a schematic sectional view of the floor, wall and ceiling cladding with adhesive layers adapted to the support layer, and

FIG. 9 shows a schematic sectional view of the floor, wall and ceiling cladding including an adhesive layer comprising two backings.

### DETAILED DESCRIPTION OF PREFERRED EMBODIMENTS

Preferred embodiments based on the Figures are described hereinafter. In this, identical or similar elements or elements with the same effect are referenced with identical reference numerals in the different Figures, and these elements are not repeatedly described so as to avoid redundancies.

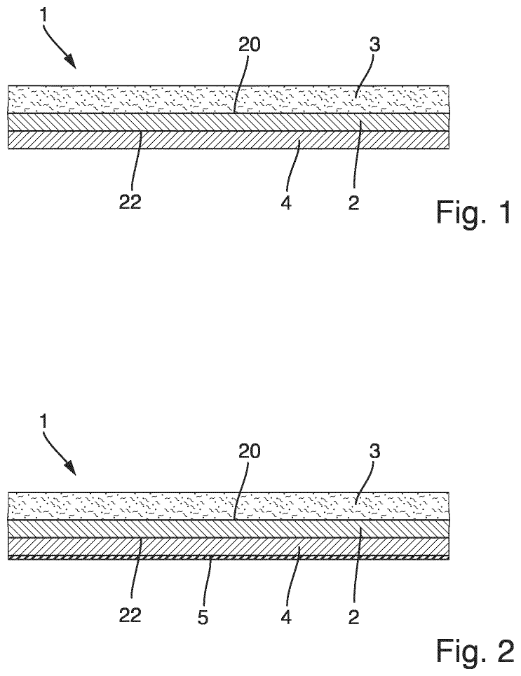

FIG. 1 shows a sectional view of a floor, wall and ceiling cladding 1. The floor, wall and ceiling cladding 1 consists in a layered configuration, including a support layer (2) in the form of a lightweight building board. In the case in hand, the lightweight building board is made of aluminium. Alternatively, the lightweight building board also can be made of plastic. Made from the plastics. For example, lightweight building boards made of fibre composites can be used, such as reinforcing fibres embedded in a polymer matrix. Carbon fibres, glass fibres, plastic fibres, natural fibres and/or metal fibres can be used as reinforcing fibres.

Support layer 2 has a first surface 20 and a second surface 22. The first surface 20 is coated with a first top coating 3. The first top coating can me made of epoxy resin, polyurethane or polyurea, which originally are sprayed on the first surface 20 of the support layer 2 in the form of a resin curing agent mixture. For the embodiment in hand, the solvent-free two-component reactive spray coating VIASEAL LCT1616-60 by the company VIACOR Polymer GmbH is used. It has excellent resilient properties and serves as an anti-slip coating. The cured product has a tensile strength of at least 11 N/mm² (DIN 53504), elongation at break of at least 300% (DIN 53504) and a shore-A hardness of ca. 88 (5 d/23° C.) (DIN EN ISO 868). Moreover, when spraying the first top coating 3 onto the first surface 20 hard grain can be included so as to increase roughness of a first outer surface of the first top coating 3. In the latter case, alternatively, also the solvent-free two-component reactive spray VIASEAL LCT1622-60 by the company VIACOR Polymer GmbH can be used as a first top coating. It is comparatively harder and is thus well-suited for incorporating granulate such as, for example, hard grain.

The combination consisting in the support layer 2 and the first top coating 3 is resistant to high mechanical loads and large temperature differences. Moreover, the bond between the support layer 2 and the first top coating 3 withstands strong deformations, too.

An adhesive fastening 4 is arranged on the second surface 22 of the support layer 2 in the form of a backing-based adhesive tape, whereas the backing comprises a soft foam. By way of the adhesive fastening (4), the floor, wall and ceiling cladding can be glued to the respective site of use. In the alternative, the adhesive fastening can also comprise a transfer adhesive tape, i.e. a tape without backing. Thus, due to the resilience properties of the adhesive fastening, irregularities in the surface elements are to be affixed to can be levelled out.

Walls, ceilings and floors can be functionalised by applying the floor, wall and ceiling cladding. This also comprises protective functions such as for example noise and thermal insulation or impact protection, moreover, anti-slip or slide-enhancing properties can be provided retroactively. In order to equip the walls, ceilings and floors with the above properties, the floor, wall and ceiling cladding 1 can be installed as finished products requiring just a few work steps.

The support layer (2) in the form of an aluminium lightweight building board gives the wall and ceiling cladding sufficient hardness and stiffness properties whilst keeping its weight relatively low. By way of the adhesive fastening (4), the floor, wall and ceiling cladding can be fastened to various walls, ceilings or floors. By way of example: concrete walls, ceilings and floors, plastered walls, wooden walls, wooden ceilings and wooden floors, etc.

FIG. 2 shows the floor, wall and ceiling cladding from FIG. 1, additionally including a tear-off film (5) on the outer surface of the adhesive fastening 4. The tear-off film 5 can remain on the adhesive fastening (4) just up until the floor, wall and ceiling cladding is installed.

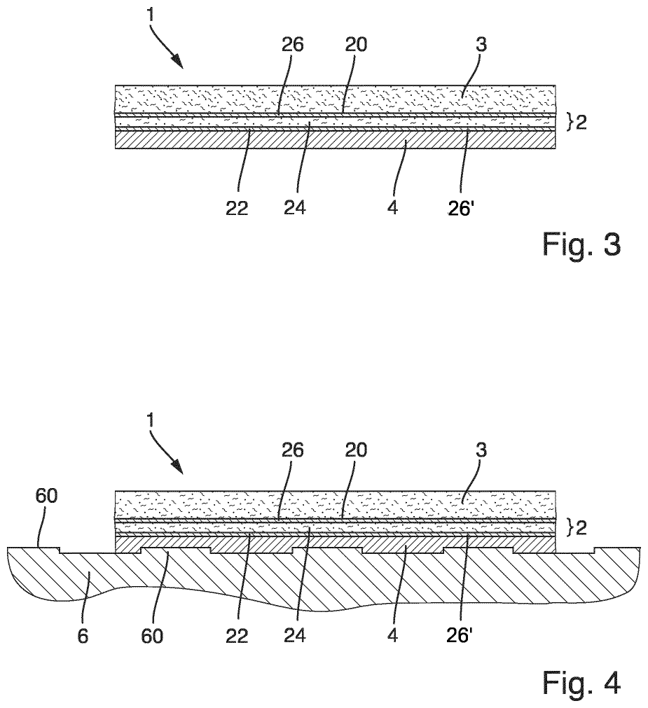

FIG. 3 shows a schematic sectional view of a layer construction of a floor, wall and ceiling cladding (1) including a support layer (2) in the form of a lightweight building board comprising a polymer foam 24 encased between two aluminium layers. The polymer foam 24 is made of polypropylene, which is characterised by particularly low density. A support layer 2, consisting in two aluminium layers 26, 26′ and a polypropylene polymer foam layer encased in between these layers is characterised by high strength and comparatively low weight and small layer thickness.

Moreover, the polymer foam 24 comes with the advantage that it is malleable. For example, the floor, wall and ceiling cladding (1) can be assembled seamlessly across corners such as the transitional area between the floor and a wall. Moreover, the polymer foam (24) encased between the aluminium layers (26), (26′) is characterised by good thermal insulation properties. The adhesive fastening (4) shown in FIG. 3 is formed by a transfer adhesive tape and is glued to the side of the aluminium layer 26′ facing away from the polymer foam (24).

FIG. 4 shows the floor, wall and ceiling cladding (1) from FIG. 3, whereas the adhesive fastening (4) compensates for unevenness of the surface (6) of the ceiling or the floor. Such an uneven surface (6) may for example also be caused by a plaster layer on a wall. The adhesive fastening (4) is a transfer adhesive tape. In FIG. 4, unevenness is shown as protrusions (60). The adhesive fastening (4) thus allows for almost constant performance of the floor, wall and ceiling cladding, regardless of the condition of the surface.

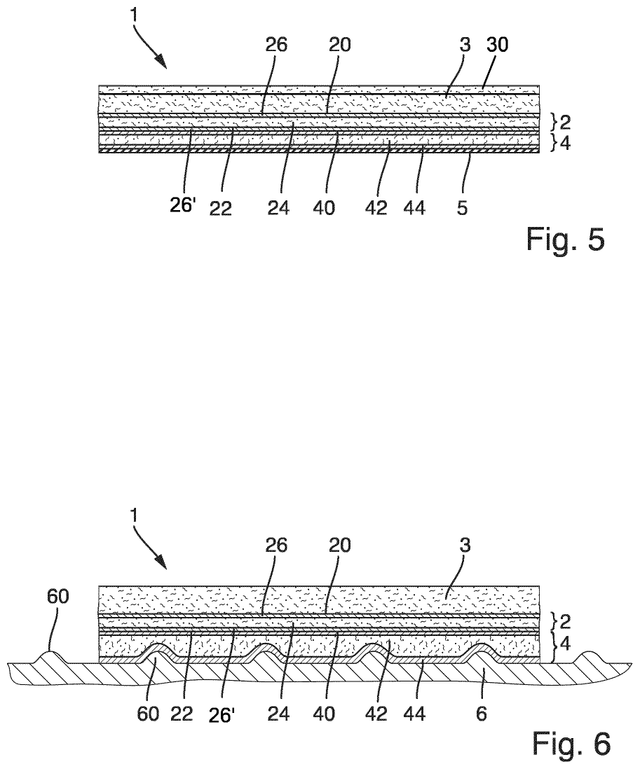

FIG. 5 shows a floor, wall and ceiling cladding (1) similar to the floor, wall and ceiling cladding shown in FIG. 3. In contrast to the transfer adhesive tape shown in FIG. 3 the floor, wall and ceiling cladding (1) shown in FIG. 5 includes adhesive fastening (4) in the form of a backing-based adhesive tape. The backing-based adhesive tape forms a double-sided adhesive tape, comprising a first adhesive layer (40), a backing (42) and a second adhesive layer (44). The backing (42) is arranged between the first adhesive layer (4) and the second adhesive layer (44). The first adhesive layer (40) abuts the aluminium layer (26′) of the backing layer (2). A tear-off film (5) is arranged on the bottom surface of the second adhesive layer (44).

Moreover, the floor, wall and ceiling cladding (1) shown in FIG. 5 includes a second top coating (30) on the first top coating (3). The second top coating may for example provide an additional function and apart from polyurethane, polyurea and/or epoxy resin may for example include further functional materials. For example, the second layer may include soot particles or electrically conductive fibres in order to give the surface of the floor, wall and ceiling cladding (1) increased electric conductivity.

FIG. 6 shows the floor, wall and ceiling cladding (1) from FIG. 5, whereas the adhesive fastening (4) compensates for unevenness of the surface (6) of a wall, ceiling or floor. The floor, wall and ceiling cladding (1) is glued to the surface (6) and therefore no longer includes the tear-off film.

The protrusions (60) protruding from the surface (6) are compensated for by the adhesive fastening (4). The second adhesive layer (44) follows the profile of the surface (6). The thickness of the second adhesive layer (44) remains almost constant. The backing (42), in turn, is compressed in the areas of the protrusions (60). Thus it is possible to install the floor, wall and ceiling cladding (1) also on uneven, for example serrated surfaces without the adhesive bond between the floor, wall and ceiling cladding (1) and the surface (6) being compromised.

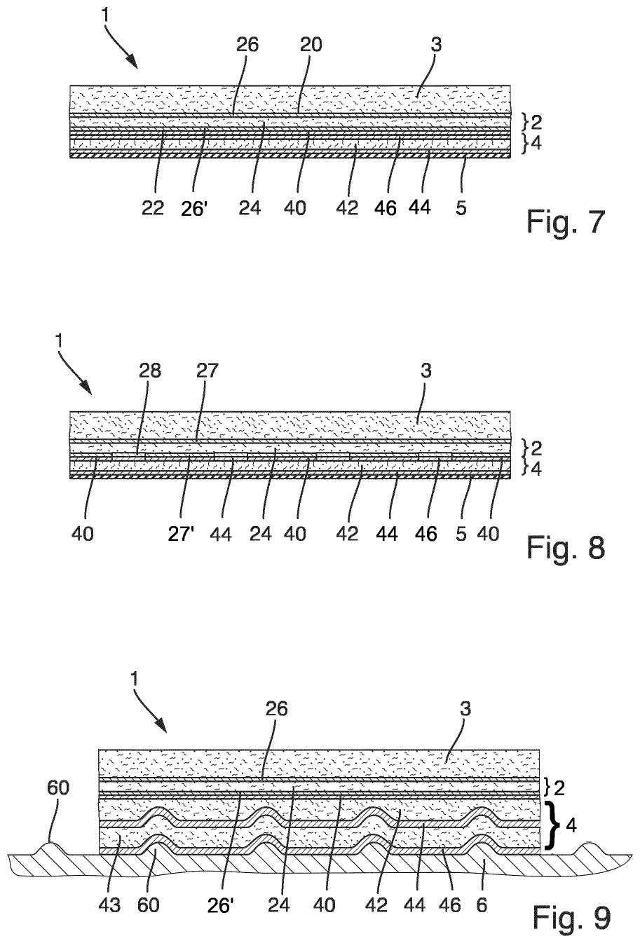

FIG. 7 shows a floor, wall and ceiling cladding (1) similar to the floor, wall and ceiling cladding shown in FIG. 5. The adhesive fastening (4) deviates from the adhesive layer shown in FIG. 5 in that it comprises an additional adhesive layer between the backing layer (2) and the backing (42). In particular, a first adhesive layer (40) is adapted to the requirements associated with creating an adhesive bond with the aluminium layer (26) and an adjacent third adhesive layer (46) is adapted to the requirements associated with creating an adhesive bond with the backing 42. By selecting the corresponding first and third adhesive layers (40), (46) depending on the materials of the support layer (2) and the backing (42), high-grade adhesion can be achieved, i.e. optimal cohesion of the compound can be ensured. A second adhesive layer (44) is applied on the bottom surface of the backing (42). In its non-assembled state, the bottom side of the adhesive fastening (4) is sealed with a tear-off film (5).

FIG. 8 shows a floor, wall and ceiling cladding (1) according to FIG. 5 with the only difference that the bottom surface of the support layer 2 exhibits different materials. One glass fibre layer (27′) is arranged alternating with a carbon fibre layer (28). Moreover, the adhesive fastening (4) is adapted to the different material pairing of the support layer (2) so that a first adhesive layer (40) contacts the glass fibre layer (27′) and a third adhesive layer (46) contacts the carbon fibre layer (28). By selecting the corresponding first and third adhesive layers (40), (46) depending on the materials of the support layer (2), high-grade adhesion can be achieved, i.e. optimal cohesion of the compound can be ensured. A second adhesive layer (44) is applied on the bottom surface of the backing (42). In its non-assembled state, the bottom side of the adhesive fastening (4) is sealed with a tear-off film (5).

FIG. 9 shows a floor, wall and ceiling cladding (1) according to FIG. 6 with the only difference that the adhesive fastening (4) comprises another backing (43) and a third adhesive layer (46). The adhesive fastening (4) has the following layer sequence: first adhesive layer (40), backing (42), second adhesive layer (44), backing (43) and third adhesive layer. The protrusions (60) protruding from the surface (6) are compensated for by the adhesive fastening (4). The second and third adhesive layers (44), (46) follow the profile of the surface (6). The thickness of the second and third adhesive layers (44), (46) remains almost constant. The backings (42), (43) in turn, are compressed in the areas of the protrusions (60).

In yet another embodiment the floor, wall and ceiling cladding is glued to a mirroring floor, wall and ceiling cladding to form a free-standing wall-section. Thus, a wall element is obtained exhibiting the following layer configuration: first top coating, support layer, adhesive fastening, adhesive fastening, support layer and first top coating. Such a wall element exhibits the functionality of the first top coatings on both outer surfaces. The wall element described above is suitable as an easy to install partitioning wall. Alternatively, the adhesive fastening can be dispensed with entirely. In that case, a support layer is equipped with a first top coating on both sides, i.e., on its first and second surface.

As far as applicable, all individual features shown in the individual embodiments can be combined and/or exchanged without leaving the scope of the invention.

### LIST OF REFERENCE NUMERALS

1 Floor, wall, and ceiling cladding
2 Support layer
20 First surface
22 Second surface
24 Polymer foam
26, 26′ Aluminium layer
27, 27′ Glass fibre layer
28 Carbon fibre layer
3 First top coating
30 Second top coating
4 Adhesive fastening
40 First adhesive layer
42 Backing
43 Backing
44 Second adhesive layer
46 Third adhesive layer
5 Tear-off film
6 Surface
60 Protrusion

1. A floor, wall, and ceiling cladding for protection, damping and insulation purposes,
wherein
a combination is comprised of a support layer having a first surface and a second surface, wherein the support layer comprises a lightweight building board,
a first top coating arranged on the first surface, said first top coating comprising a polyurethane, polyurea and/or epoxy resin, and
an adhesive fastening arranged on the second surface.

2. The floor, wall, and ceiling cladding of claim 1 wherein the lightweight building board comprises materials selected from the group comprising plastics, lightweight metals, fibre-reinforced composites or any combination thereof.

3. The floor, wall and ceiling cladding of claim 1 wherein a second top coating is arranged on the first top coating.

4. The floor, wall, and ceiling of claim 1 wherein the lightweight building board comprises a polymer encased between two aluminum layers.

5. The floor, wall, and ceiling of claim 1 wherein the lightweight building board comprises a polymer foam encased between two aluminum layers.

6. The floor, wall, and ceiling cladding according to claim 5, wherein the polymer foam is a polypropylene foam or a polyethylene foam.

7. The floor, wall, and ceiling cladding of claim 1 wherein the strength properties of the lightweight building board are higher than the strength properties of the first top coating.

8. The floor, wall, and ceiling cladding of claim 1 wherein the first top coating has an anti-slip coefficient of at least R10.

9. The floor, wall, and ceiling cladding of claim 1 wherein the first top coating has an slide-friction coefficient of at least 0.6 μD.

10. The floor, wall, and ceiling cladding of claim 1 wherein the first top coating has an outer surface that is smooth, rough or structured.

11. The floor, wall, and ceiling cladding of claim 1 wherein the first top coating and/or a second top coating comprises nano-parts coated with a wax-like layer for providing a hydrophobic surface.

12. The floor, wall, and ceiling cladding of claim 1 wherein the first top coating and/or a second top coating comprises bound silver ions, copper ions and/or terbutryn.

13. The floor, wall, and ceiling cladding of claim 1 wherein the first top coating and/or a second top coating comprises a fabric consisting in aluminium, stainless steel, copper or carbon fibres.

14. The floor, wall, and ceiling cladding of claim 1 wherein the first top coating and/or a second top coating comprises soot particles or electrically conductive fibres.

15. The floor, wall, and ceiling cladding of claim 1 wherein the adhesive fastening comprises a backing-based adhesive tape, a transfer adhesive tape or a liquid adhesive.

16. The floor, wall, and ceiling cladding of claim 1 wherein the backing-based adhesive tape comprises a soft elastic backing.

17. The floor, wall, and ceiling cladding of claim 1 wherein the adhesive fastening comprises acrylate, polyurethane, epoxies, silicone and/or natural rubber.

18. The floor, wall, and ceiling cladding of claim 1 wherein a tear off film is arranged on one outer surface of the adhesive fastening.

19. The floor, wall, and ceiling cladding of claim 1 wherein an additional fastening means is integrated in the layer design of the first top coating, the support layer, and/or the adhesive fastening, for fastening the floor, wall, and ceiling cladding to a floor, a wall, or a ceiling.

20. The floor, wall, and ceiling cladding of claim 1 wherein at least one transponder is integrated in the support layer of the first top coating, preferably an RFID transponder.

21. The floor, wall and ceiling cladding of claim 1 wherein at least one line is integrated in the support layer of the first top coating, preferably an electric line.

22. The floor, wall, and ceiling cladding for to claim 1, wherein the floor, wall, and ceiling cladding are configured as a wall element.

23. The floor, wall, and ceiling cladding of claim 1, wherein the floor, wall, and ceiling cladding are configured as an adhesive tile.

24. The floor, wall, and ceiling cladding of claim 1, wherein the floor, wall, and ceiling cladding are configured as a floor element.

25. The floor, wall, and ceiling cladding of claim 1, wherein the floor, wall, and ceiling cladding are configured as a ceiling element.

26. A method for manufacturing a floor, wall and ceiling cladding of claim 1, comprising:
providing the support layer,
applying the adhesive fastening on the second surface of the support layer (2), and coating the first surface of the support layer with the first top coating using a spraying or casting method.

27. The method for producing a floor, wall, and ceiling cladding of claim 26, wherein when coating the support layer with the first top coating, solid bodies such as hard grain are sprayed or cast together with the coating.

28. The method for manufacturing a motor or utility vehicle supporting device of claim 26, wherein a final spray coating step the spray coat is applied from a distance calculated such that a sprayed-on plastics starts reacting before it reaches the first top coating or a second top coating (30), thus producing an uneven surface on the first top coating or the second top coating (30).
